(19) United States
(12) Patent Application Publication
(10) Pub. No.: US 2017/0075317 A1
(43) Pub. Date: Mar. 16, 2017

(54) SMART WATCH

(71) Applicant: SAMSUNG DISPLAY CO., LTD., Yongin-si (KR)

(72) Inventors: Jaehyung Cho, Suwon-si (KR); Ahyoung Son, Seoul (KR); Soo-wan Yoon, Hwaseong-si (KR); Myungho Lee, Anyang-si (KR)

(21) Appl. No.: 15/139,203

(22) Filed: Apr. 26, 2016

(30) Foreign Application Priority Data
Sep. 15, 2015 (KR) 10-2015-0130579

(51) Int. Cl. G04G 21/08; G04G 9/06; G04B 19/04

(52) U.S. Cl. CPC G04G 21/08; G04B 19/04; G04G 9/06

(57) ABSTRACT

A smart watch includes: a housing; a window member connected to the housing; a display panel located in the housing, the display panel to display an image toward the window member; an analog movement located in the housing; a first time hand module to rotate by an operation of the analog movement; and an electronic module to control the display panel and the analog movement. The first time hand module includes: a first rotational shaft connected to the analog movement; a first horizontal portion connected to the first rotational shaft and located below the display panel; a first vertical portion connected to the first horizontal portion and facing a side edge of the display panel; and a first time hand connected to the first vertical portion and located above the display panel.

### CROSS-REFERENCE TO RELATED APPLICATIONS

This application claims priority to and the benefit of Korean Patent Application No. 10-2015-0130579, filed on Sep. 15, 2015, the entire contents of which are hereby incorporated by reference.

### BACKGROUND

1. Field

One or more aspects of example embodiments of the present invention relate to a smart watch.

2. Description of the Related Art

Various electronic devices, such as televisions, mobile phones, navigation units, computer monitors, and game consoles, that may provide multimedia, are being developed. Especially, various portable electronic devices, such as mobile phones and tablets, are being developed. Also, smart watches that interact and work together with the portable electronic devices are being developed.

### SUMMARY

One or more aspects of example embodiments of the present invention relate to an analog-digital hybrid type smart watch.

One or more aspects of example embodiments of the present invention provide a smart watch including a display panel that may have a simple shape.

According to an example embodiment of the present invention, a smart watch includes: a housing; a window member coupled to the housing; a display panel located in the housing, the display panel being configured to display an image toward the window member; an analog movement located in the housing; a first time hand module configured to rotate by an operation of the analog movement; and an electronic module configured to control the display panel and the analog movement, the first time hand module including: a first rotational shaft coupled to the analog movement; a first horizontal portion coupled to the first rotational shaft and located below the display panel; a first vertical portion coupled to the first horizontal portion and facing a side edge of the display panel; and a first time hand coupled to the first vertical portion and located above the display panel.

In an embodiment, the first horizontal portion may include a rotational plate having a first opening, and the first vertical portion may include a cylindrical shaped partition coupled to the rotational plate and surrounding the side edge of the display panel.

In an embodiment, the first rotational shaft may have a cylindrical shape and may define a cavity corresponding to the first opening.

In an embodiment, the analog movement may have a second opening corresponding to the first opening.

In an embodiment, the first time hand may include a transparent portion coupled to the first vertical portion and a color portion coupled to the transparent portion.

In an embodiment, the smart watch may further include a second time hand module configured to rotate by an operation of the analog movement, and to provide time information that is different from that of the first time hand module.

In an embodiment, the second time hand module may include: a second rotational shaft coupled to the analog movement and surrounding the first rotational shaft; a second horizontal portion coupled to the second rotational shaft and located below the display panel; a second vertical portion coupled to the second horizontal portion and facing the side edge of the display panel; and a second time hand coupled to the second vertical portion and located above the display panel.

In an embodiment, the smart watch may further include a touch panel coupled to the window member or the display panel,

In an embodiment, the electronic module may include: a controller configured to provide control signals to the display panel and to the touch panel; and a power supply configured to provide a power voltage to the analog movement.

In an embodiment, the smart watch may further include a band coupled to the housing and configured to be worn on a wrist of a user.

According to an example embodiment of the present invention, a smart watch includes: a housing; a window member coupled to the housing; a display panel located in the housing, the display panel being configured to display an image toward the window member; an analog movement located in the housing, the analog movement including a rotational shaft; a time module configured to rotate by an operation of the rotational shaft; and an electronic module configured to control the display panel and the analog movement, the time hand module including: a rotational plate coupled to the rotational shaft and located below the display panel; a cylindrical shaped partition coupled to the rotational shaft and surrounding a side edge of the display panel; and a time hand coupled to the cylindrical shaped partition and located above the display panel.

In an embodiment, a first opening may be in the rotational plate.

In an embodiment, the rotational shaft may have a cylindrical shape and may define a cavity corresponding to the first opening.

In an embodiment, the analog movement may have a second opening corresponding to the first opening.

In an embodiment, the time hand may include a transparent portion coupled to the cylindrical shaped partition and a color portion coupled to the transparent portion.

In an embodiment, the smart watch may further include a touch panel coupled to the window member or the display panel.

In an embodiment, the electronic module may include: a controller configured to provide control signals to the display panel and to the touch panel; and a power supply configured to provide a power voltage to the analog movement.

### BRIEF DESCRIPTION OF THE FIGURES

The accompanying drawings are included to provide a further understanding of the present invention, and are incorporated in and constitute a part of this specification. The drawings illustrate exemplary embodiments of the present invention, and together with the description, serve to explain aspects and features of the present invention. In the drawings:

FIG. 1 is a perspective view of a smart watch according to an embodiment of the present invention;

FIG. 2 is a block diagram of a watch assembly WA according to an embodiment of the present invention;

FIG. 3 is a perspective view of the watch assembly according to an embodiment of the present invention;

FIG. 4 is a cross-sectional view of the watch assembly according to an embodiment of the present invention;

FIG. 5 is an exploded perspective view of the watch assembly according to an embodiment of the present invention;

FIGS. 6A-6B are perspective views of a time hand module according to one or more embodiments of the present invention;

FIG. 7 is a cross-sectional view illustrating an example of the watch assembly according to another embodiment of the present invention;

FIG. 8A is a cross-sectional view illustrating an example of the watch assembly according to another embodiment of the present invention;

FIG. 8B is an exploded perspective view of the watch assembly according to an embodiment of the present invention; and

FIG. 9 is an exploded perspective view of a time hand module and an analog movement according to an embodiment of the present invention.

### DETAILED DESCRIPTION

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

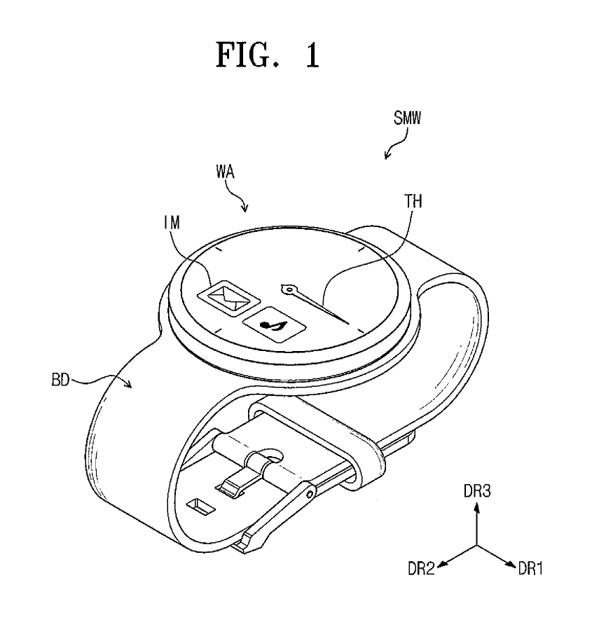

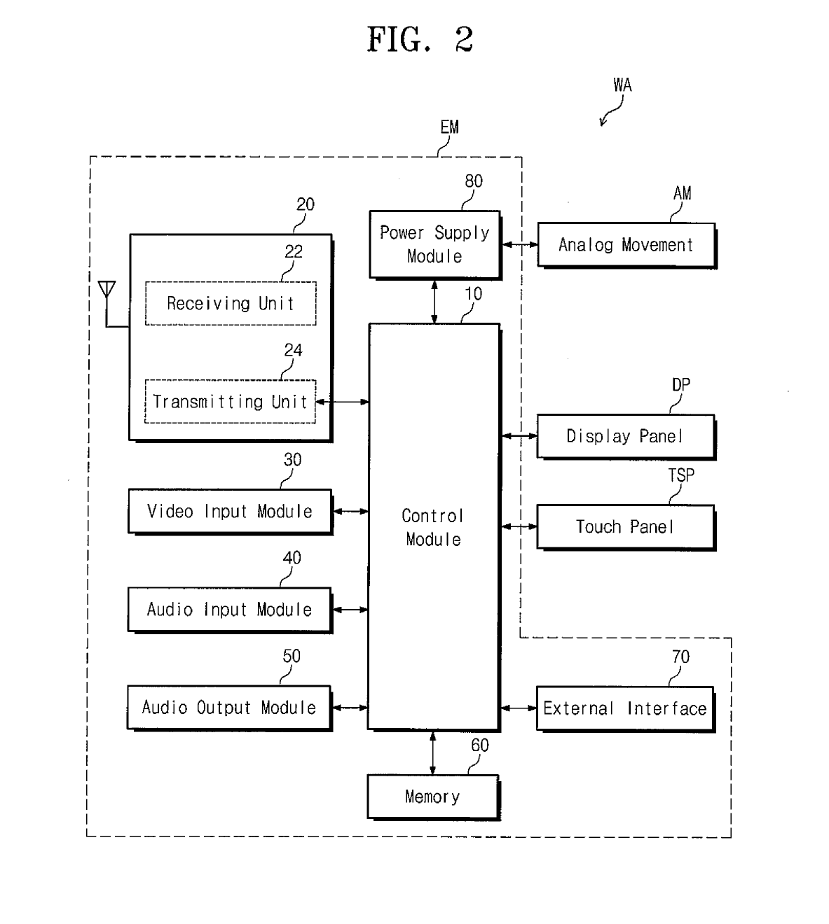

FIG. 1 is a perspective view of a smart watch SMW according to an embodiment of the present invention. FIG. 2 is a block diagram of a watch assembly WA according to an embodiment of the present invention. Hereinafter, the smart watch SMW according to an embodiment of the present invention will be described with reference to FIGS. 1 and 2.

As illustrated in FIG. 1, the smart watch SMW includes a watch assembly WA and a band BD. The watch assembly WA displays an image IM having information (e.g., predetermined information). A time hand TH of the watch assembly WA provides time information.

The image IM is displayed on a display surface defined by a first direction axis DR1 and a second direction axis DR2. A third direction axis DR3 represents a direction normal to the display surface. The third direction axis DR3 is a reference axis for distinguishing front and rear surfaces of components constituting the watch assembly WA. Directions indicated by the first to third direction axes DR1 to DR3 may be relative, and thus, may include (or be converted into) other directions.

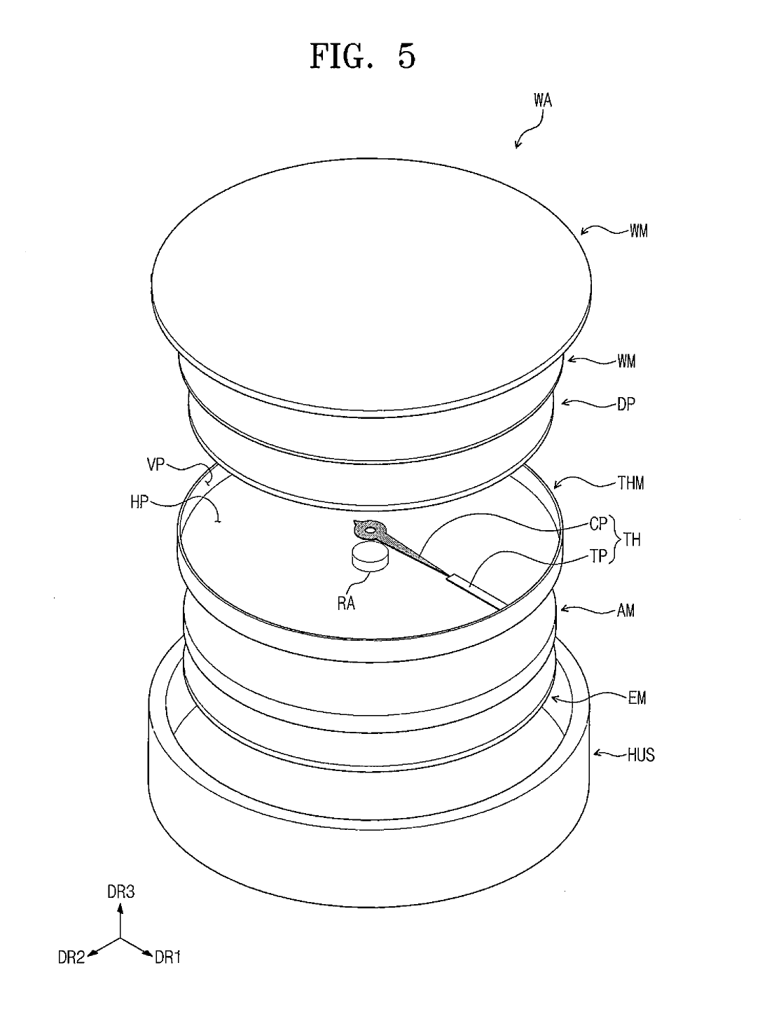

Although the band BD is coupled to the watch assembly WA, for example, through a housing (see reference symbol HUS in FIG. 4), and is configured to be worn on a wrist of a user, the present invention is not limited thereto. For example, in one or more embodiments, the band BD may be configured to be worn on an arm of the user and/or configured to be hung on a neck of the user. In one or more embodiments, the band BD may be replaced by a watch cradle for installing or coupling the watch assembly WA to other electronic devices.

As illustrated in FIG. 2, the watch assembly WA includes a display panel DP, a touch panel TSP, an analog movement AM, and an electronic module EM. According to one or more embodiments of the present invention, the touch panel TSP may be omitted. According to one or more embodiments of the present invention, the touch panel TSP may be integrated into the display panel, or may be replaced by a keypad and/or the like.

The display panel DP generates the image IM (e.g., see FIG. 1). Although the display panel is described as including an organic light emitting display panel, the present invention is not limited thereto, and in other embodiments, a liquid crystal display panel, an electrophoretic display panel, and/or the like may be included. The touch panel TSP senses an external input. The external input may be generated by a finger of the user, a stylus pen, and/or the like. Although the touch panel TSP is described as including a capacitive type touch panel, the present invention is not limited thereto, and in other embodiments, an acoustic wave type touch panel, and/or an electromagnetic type touch panel may be included.

The analog movement AM operates the time hand to provide time information. The analog movement AM may be an assembly of a plurality of fine components. For example, any suitable analog movement AM of a watch may be applied. Although the analog movement AM is described as a quartz movement in the present example embodiment, according to other embodiments, a mechanical movement or any suitable movement may be applied thereto.

The electronic module EM includes various functional modules and/or components for operating the watch assembly WA. The electronic module EM may include a control module (e.g., a controller) 10, a wireless communication module (e.g., a wireless communication device) 20, a video input module (e.g., a video input device) 30, an audio input module (e.g., a microphone or an audio input device) 40, an audio output module (e.g., a speaker or an audio output device) 50, an external interface 70, a power supply module (e.g., a power supply or a power supply source) 80, and/or the like. The modules (or devices) may be mounted on a circuit board or may be electrically connected through a flexible circuit board. In or more embodiments of the present invention, the electronic module EM may further include a camera module (e.g., a camera or a camera device).

The control module 10 controls an overall operation of the smart watch. For example, the control module 10 activates or deactivates the display panel DP and the touch panel TSP. The control module 10 may control, based on a touch signal inputted from the touch panel TSP, the display panel DP, the video input module 30, the audio input module 40, the audio output module 50, and/or the like.

The wireless communication module 20 may use a Bluetooth or Wi-Fi connection (e.g., interconnection) to transmit/receive a wireless signal to/from other terminals and/or devices. The wireless communication module 20 may use a general communication connection (e.g., interconnection) to transmit/receive an audio signal. The wireless communication module 20 includes a transmission unit (e.g., a transmitter) 22 that modulates the signal to be transmitted and to transmit the modulated signal, and a receiving unit (e.g., a receiver) 24 that demodulates the received signal.

The video input module 30 processes a video signal to convert the video signal into video data to be displayed on the display panel DP. The audio input module 40 receives an external audio signal through a microphone in a recording mode, a voice recognition mode, and/or the like, to convert the signal into electrical audio data. The audio output module 50 converts the audio data received from the wireless communication module 20 and/or the audio data stored in a memory 60, to output the converted audio data to the outside.

An external interface 70 serves as an interface connected to an external charger, a wired/wireless data port, a card socket (e.g., a memory card and/or a SIM/UIM card), and/or the like. The power supply module 80 supplies power for an overall operation of the watch assembly WA.

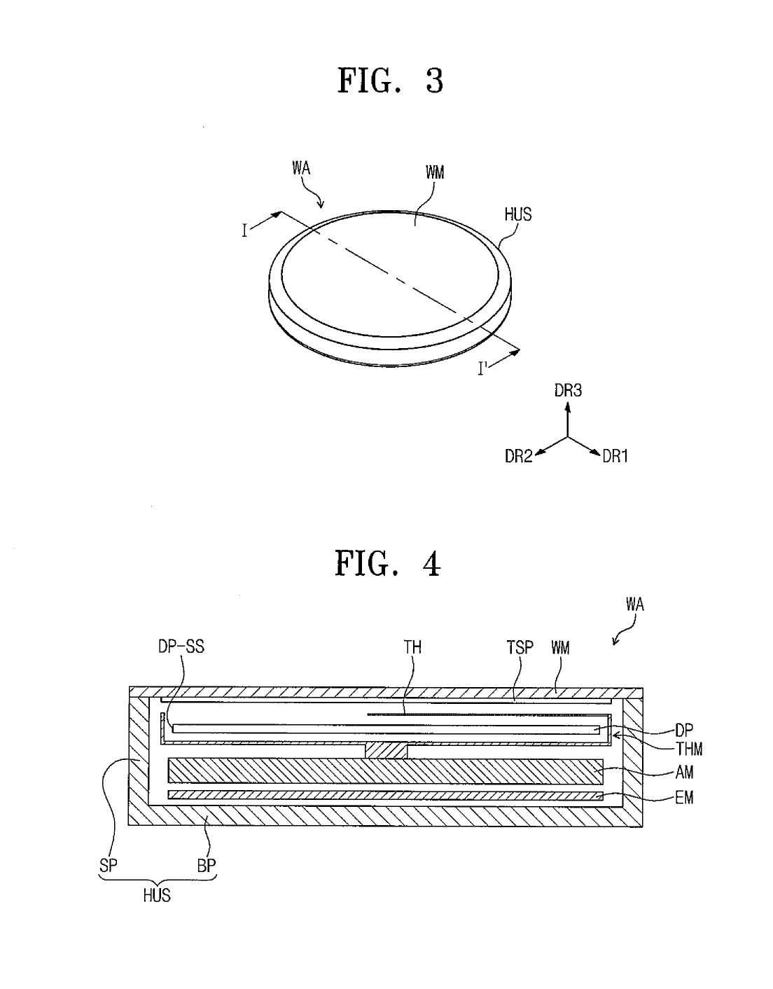

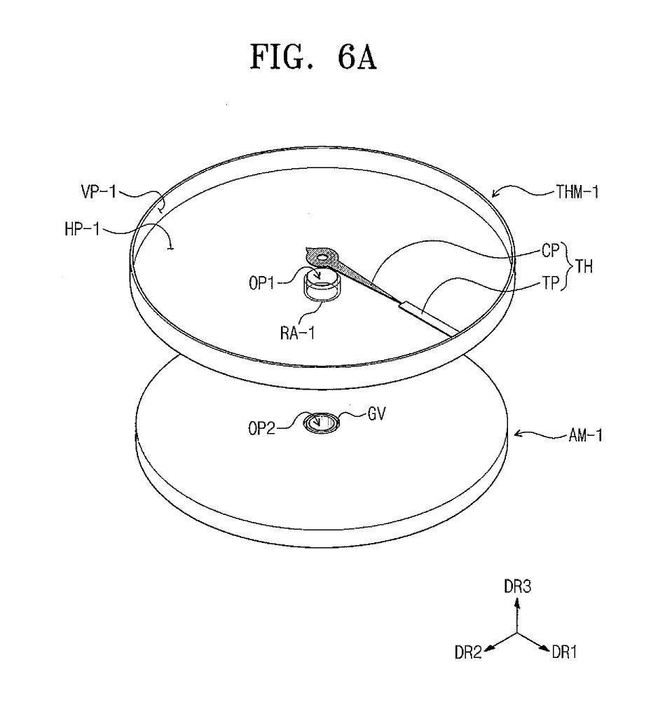

FIG. 3 is a perspective view of the watch assembly WA according to an embodiment of the present invention. FIG. 4 is a cross-sectional view of the watch assembly WA according to an embodiment of the present invention. FIG. 5 is an exploded perspective view of the watch assembly WA according to an embodiment of the present invention. Hereinafter, the watch assembly WA will be described in more detail with reference to FIGS. 3 to 5.

The watch assembly WA may further include a housing HUS, a window member WM, and a time hand module THM, in addition to the components described with reference to FIG. 2.

The housing HUS and the window member WM are coupled to each other to constitute an appearance of the watch assembly. Other components are accommodated in an inner space provided by the housing HUS and the window member WM. The housing HUS may include a metal frame, such as stainless steel, a glass frame, and/or the like. The window member WM may include various functional coating layers, such as a transparent base substrate. The base substrate may include a glass substrate, a sapphire substrate, a plastic substrate, and/or the like. The functional coating layer may include an anti-reflection layer, an anti-fingerprint layer, a hard coating layer, and/or the like.

The housing HUS includes a bottom portion BP and a sidewall portion SP connected to (e.g., bent from) the bottom portion BP toward a third direction axis DR3. The bottom portion BP may have a circular shape on a plane defined by the first direction axis DR1 and the second direction axis DR2. The sidewall portion SP may have a cylindrical shape that provides a cavity.

The electronic module EM is located on the bottom portion BP. The analog movement AM is located on the electronic module EM. Positions of the electronic module EM and the analog movement AM may be switched from each other. The display panel DP is located on the analog movement AM. The display panel DP may have a circular shape on the plane defined by the first direction axis DR1 and the second direction axis DR2.

The window member WM is coupled to the sidewall portion SP of the housing HUS. The touch panel TSP may be coupled to a bottom surface of the window member WM.

The time hand module THM is coupled to the analog movement AM. The time hand module THM includes a rotational shaft RA, a horizontal portion HP, a vertical portion VP, and a time hand TH. The rotational shaft RA is coupled (e.g., directly coupled) to the analog movement AM. The horizontal portion HP is coupled to the rotational shaft RA, and may be located below the display panel DP. The vertical portion VP is coupled to the horizontal portion HP, and faces a side surface (e.g., a side edge) DP-SS of the display panel DP. The time hand TH is coupled to the vertical portion VP and may be located above the display panel DP.

The horizontal portion HP may include a rotational plate. The rotational plate may have a shape that is the same as or similar to that of the display panel DP, and may have an area larger than that of the display panel DP on the plane defined by the first direction axis DR1 and the second direction axis DR2. The vertical portion VP may include a cylindrical shaped partition coupled to the rotational plate and surrounding the side surface DP-SS of the display panel DP.

The time hand TH may include a transparent portion TP connected to the vertical portion VP, and a color portion CP connected to the transparent portion TP. The transparent portion TP may be a base material by itself, and the color portion CP may further include a color layer located on a surface (e.g., one surface) of the base material. The color layer includes dyes and/or pigments. Accordingly, it may appear to the user that only the color portion CP constitutes the time hand.

According to an embodiment, an opening is not defined in the display panel DP. Accordingly, the rotational shaft RA may not pass through the display panel DP.

The rotational shaft RA may detour the display panel DP (e.g., wrap around the display panel DP via the time hand module THM), and may be connected to the time hand TH. As the display panel DP may be simplified in shape, manufacturing costs thereof may be reduced, and various images may be displayed thereon.

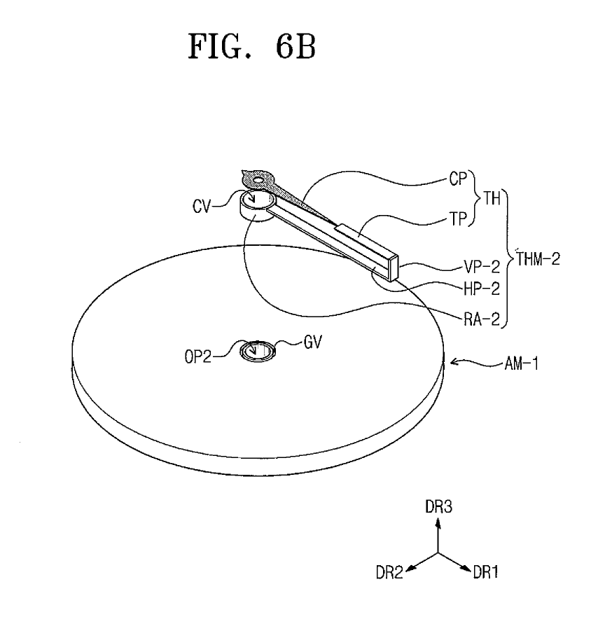

FIGS. 6A and 6B are perspective views of time hands THM-1 and THM-2 according to one or more embodiments of the present invention.

As illustrated in FIG. 6A, the time hand module THM-1 includes a rotational shaft RA-1, a horizontal portion HP-1, a vertical portion VP-1, and a time hand TH. The horizontal portion HP-1 may include a rotational plate in which a first opening OP1 is defined. The rotational shaft RA-1 may have a cylindrical shape in which a cavity corresponding to the first opening OP1 is defined.

A groove GV to which the rotational shaft RA-1 is coupled may be defined in the analog movement AM-1. Also, a second opening OP2 corresponding to the first opening OP1 may be defined in the analog movement AM-1.

The display panel (see reference symbol DP in FIG. 5) may be electrically connected to the electronic module (see reference symbol EM in FIG. 5) through a flexible circuit board or through wirings, which may be located at the first and second openings OP1 and OP2.

As illustrated in FIG. 6B, the time hand module THM-2 includes a rotational shaft RA-2, a horizontal portion HP-2, a vertical portion VP-2, and a time hand TH. Each of the horizontal portion HP-2 and the vertical portion VP-2 may have a stick shape. The rotational shaft RA-2 may have a cylindrical shape in which a cavity CV is defined.

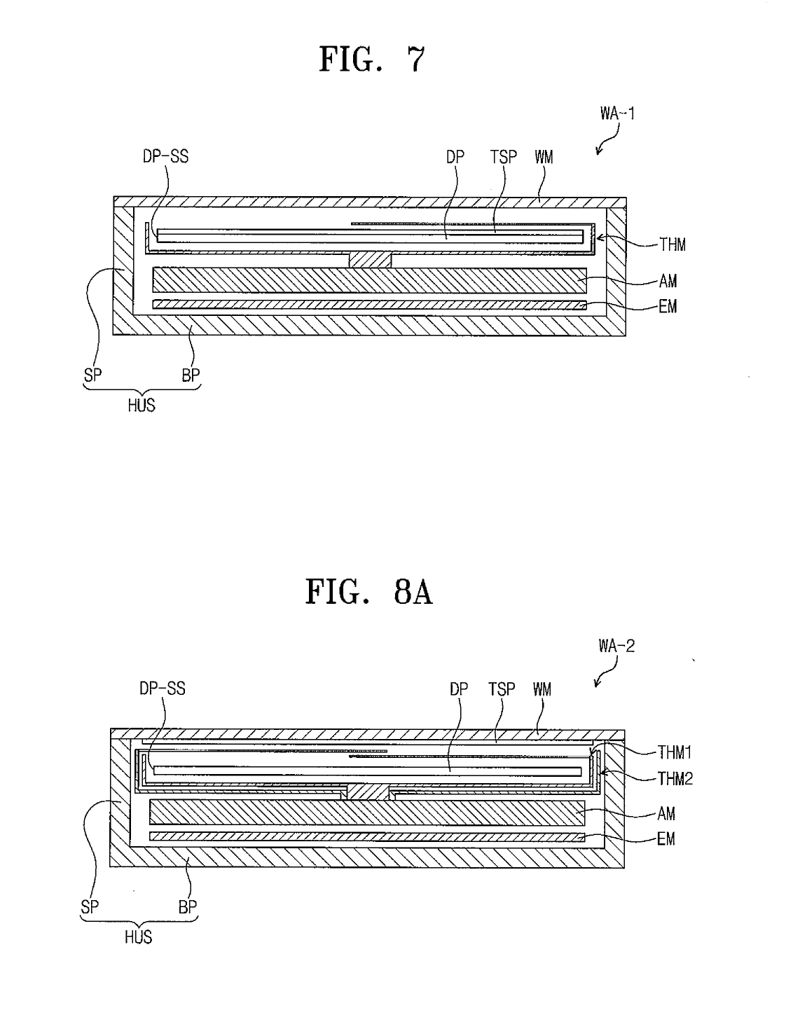

FIG. 7 is a cross-sectional view of the watch assembly WA according to an embodiment of the present invention. Unlike the watch assembly WA described with reference to FIGS. 3 to 5, the touch panel TSP may be located on the display panel DP. Here, the touch panel TSP may be an electromagnetic type touch panel.

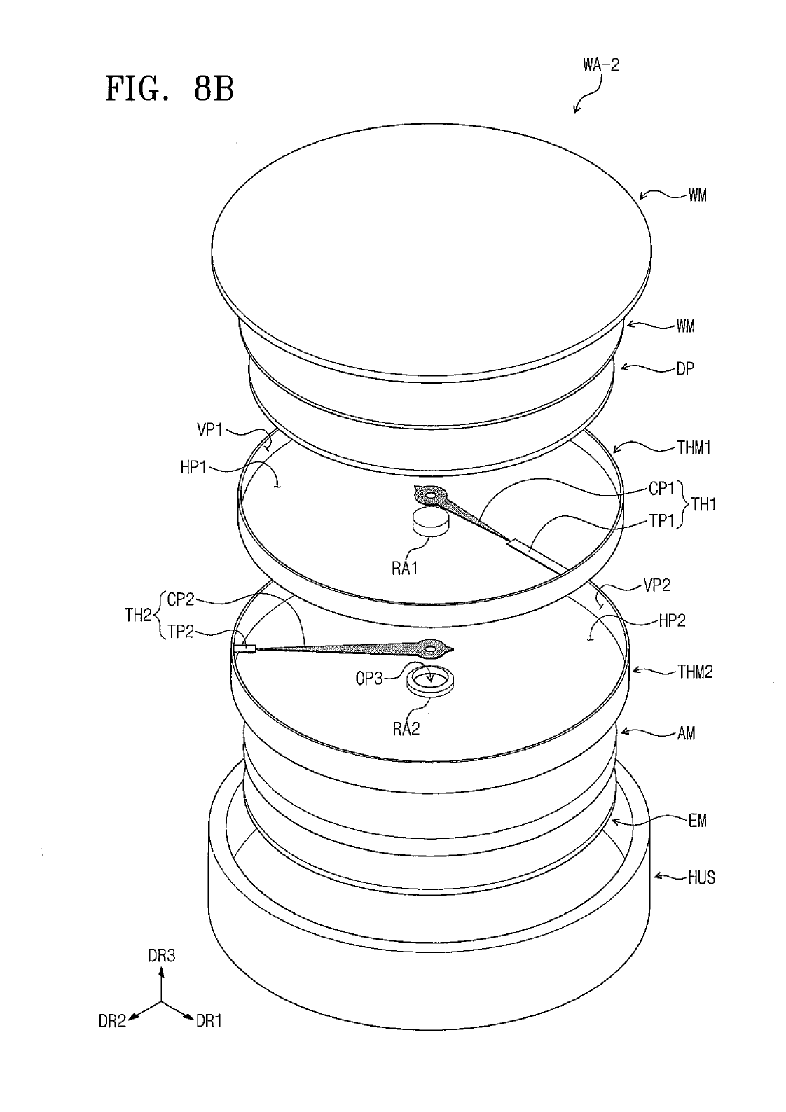

FIG. 8A is a cross-sectional view of a watch assembly WA-2 according to an embodiment of the present invention. FIG. 8B is an exploded perspective view of the watch assembly WA-2 according to an embodiment of the present invention.

The watch assembly WA-2 in FIGS. 8A and 8B includes two time hand modules THM1 and THM2, unlike the watch assembly WA described with reference to

FIGS. 3 to 5. The first time hand module THM1 of the two time hand modules THM1 and THM2 may correspond to the time hand module THM in FIGS. 3 to 5. The first time hand module THM1 includes a rotational shaft RA1, a horizontal portion HP1, a vertical portion VP1, and a time hand TH1. Detailed description for the first time hand module THM1 will not be repeated.

The first time hand module THM1 may provide hour information. The second time hand module THM2 of the two time hand modules THM1 and THM2 may provide minute information. However, the present invention is not limited thereto, and in other embodiments, the first time hand module THM1 may provide the minute information, and the second time hand module THM2 may provide the hour information.

The second time hand module THM2 includes a rotational shaft RA2, a horizontal portion HP2, a vertical portion VP2, and a time hand TH2. The horizontal portion HP2 may include a rotational plate in which an opening OP3 is defined. The rotational shaft RA2 may have a cylindrical shape in which a cavity corresponding to the opening OP3 is defined. The rotational shaft RA2 of the second time hand module THM2 may surround the rotational shaft RA1 of the first time hand module THM1. In other words, the rotational shaft RA1 of the first time hand module THM1 may be inserted into a cavity of the rotational shaft RA2 of the second time hand module THM2.

The horizontal portion HP2 of the second time hand module THM2 may be located below the display panel DP and may be located below the horizontal portion HP1 of the first time hand module THM1. The vertical portion VP2 of the second time hand module THM2 may face the side surface DP-SS of the display panel DP, and may surround the vertical portion VP1 of the first time hand module THM1.

The time hand TH2 of the second time hand module THM2 may be located above the display panel DP. The time hand TH2 of the second time hand module THM2 may include a transparent portion TP2 and a color portion CP2. The time hand TH2 of the second time hand module THM2 and the time hand TH1 of the first time hand module THM1 may overlap or partially overlap each other at a center point of the display panel DP.

Although not separately shown, according to an embodiment of the present invention, the first time hand module THM1 may be replaced by the time hand modules THM-1 and THM-2 in FIGS. 6A and 6B. According to an embodiment of the present invention, the second time hand module THM2 may be replaced by the time hand module THM-2 in FIG. 6B.

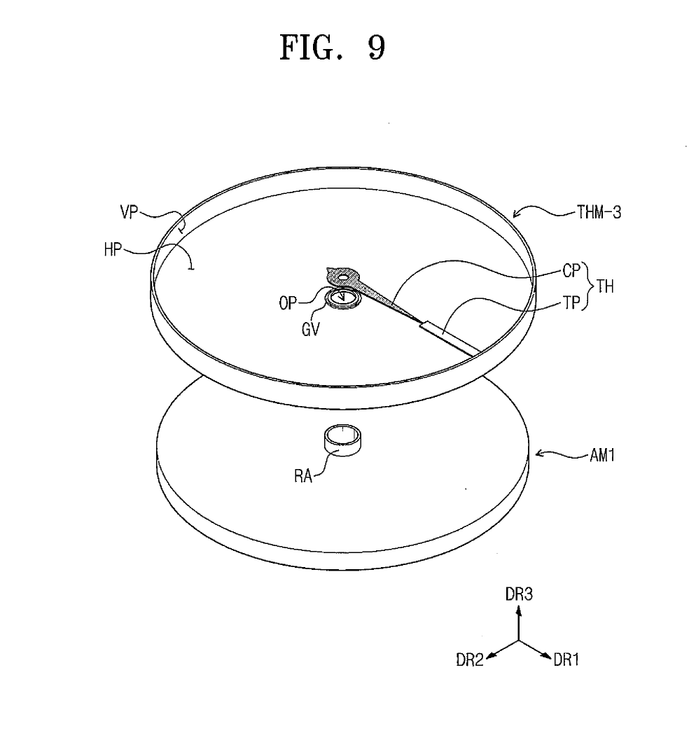

FIG. 9 is an exploded perspective view of a time hand module THM-3 and the analog movement AM1 according to an embodiment of the present invention.

Unlike the time hand modules described with reference to FIGS. 3 to 8B, the time hand module THM-3 in FIG. 9 includes a horizontal portion HP, a vertical portion VP, and a time hand TH. In other words, unlike the time hand modules described with reference to FIGS. 3 to 8B, the rotational shaft RA does not constitute a portion of the time hand module THM-3, but constitutes a portion of the analog movement AM1. Although the rotational shaft RA may be coupled to a groove GV defined in the horizontal portion HP, the present invention is not limited thereto.

According to the above-described disclosure, the opening is not defined in the display panel. The rotational shaft may not pass through the display panel, but may detour the display panel (e.g., wrap around the display panel via the time hand module), thereby being connected to the time hand. As the shape of the display panel may be simplified, the manufacturing costs thereof may be reduced, and various images may be displayed.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Although the present invention has been described with reference to the example embodiments, those skilled in the art will recognize that various changes and modifications to the described embodiments may be performed, all without departing from the spirit and scope of the present invention. Furthermore, those skilled in the various arts will recognize that the present invention described herein will suggest solutions to other tasks and adaptations for other applications. It is the applicant's intention to cover by the claims herein, all such uses of the present invention, and those changes and modifications which could be made to the example embodiments of the present invention herein chosen for the purpose of disclosure, all without departing from the spirit and scope of the present invention. Thus, the example embodiments of the present invention should be considered in all respects as illustrative and not restrictive, with the spirit and scope of the present invention being indicated by the appended claims, and their equivalents.

What is claimed is:

1. A smart watch comprising:
a housing;
a window member coupled to the housing;
a display panel located in the housing, the display panel being configured to display an image toward the window member;
an analog movement located in the housing;
a first time hand module configured to rotate by an operation of the analog movement; and
an electronic module configured to control the display panel and the analog movement,
wherein the first time hand module comprises:
a first rotational shaft coupled to the analog movement;
a first horizontal portion coupled to the first rotational shaft and located below the display panel;
a first vertical portion coupled to the first horizontal portion and facing a side edge of the display panel; and
a first time hand coupled to the first vertical portion and located above the display panel.

2. The smart watch of claim 1, wherein the first horizontal portion comprises a rotational plate having a first opening, and
the first vertical portion comprises a cylindrical shaped partition coupled to the rotational plate and surrounding the side edge of the display panel.

3. The smart watch of claim 2, wherein the first rotational shaft has a cylindrical shape and defines a cavity corresponding to the first opening.

4. The smart watch of claim 2, wherein the analog movement has a second opening corresponding to the first opening.

5. The smart watch of claim 1, wherein the first time hand comprises a transparent portion coupled to the first vertical portion and a color portion coupled to the transparent portion.

6. The smart watch of claim 1, further comprising a second time hand module configured to rotate by an operation of the analog movement, and to provide time information that is different from that of the first time hand module.

7. The smart watch of claim 6, wherein the second time hand module comprises:
a second rotational shaft coupled to the analog movement and surrounding the first rotational shaft;
a second horizontal portion coupled to the second rotational shaft and located below the display panel;
a second vertical portion coupled to the second horizontal portion and facing the side edge of the display panel; and
a second time hand coupled to the second vertical portion and located above the display panel.

8. The smart watch of claim 1, further comprising a touch panel coupled to the window member or the display panel.

9. The smart watch of claim 2, wherein the electronic module comprises:
a controller configured to provide control signals to the display panel and to the touch panel; and
a power supply configured to provide a power voltage to the analog movement.

10. The smart watch of claim 1, further comprising a band coupled to the housing and configured to be worn on a wrist of a user.

11. A smart watch comprising:
a housing;
a window member coupled to the housing;
a display panel located in the housing, the display panel being configured to display an image toward the window member;
an analog movement located in the housing, the analog movement comprising a rotational shaft;
a time module configured to rotate by an operation of the rotational shaft; and
an electronic module configured to control the display panel and the analog movement,
wherein the time hand module comprises:
a rotational plate coupled to the rotational shaft and located below the display panel;
a cylindrical shaped partition coupled to the rotational shaft and surrounding a side edge of the display panel; and
a time hand coupled to the cylindrical shaped partition and located above the display panel.

12. The smart watch of claim 11, wherein a first opening is in the rotational plate.

13. The smart watch of claim 12, wherein the rotational shaft has a cylindrical shape and defines a cavity corresponding to the first opening.

14. The smart watch of claim 13, wherein the analog movement has a second opening corresponding to the first opening.

15. The smart watch of claim 11, wherein the time hand comprises a transparent portion coupled to the cylindrical shaped partition and a color portion coupled to the transparent portion.

16. The smart watch of claim 11, further comprising a touch panel coupled to the window member or the display panel.

17. The smart watch of claim 16, wherein the electronic module comprises:
a controller configured to provide control signals to the display panel and to the touch panel; and
a power supply configured to provide a power voltage to the analog movement.
